(19) United States
(12) Patent Application Publication
(10) Pub. No.: US 2023/0339795 A1
(43) Pub. Date: Oct. 26, 2023

(54) APPARATUS AND METHOD FOR PROVIDING PURIFIED WATER

(71) Applicant: VWS (UK) LIMITED, High Wycombe Buckinghamshire (GB)

(72) Inventors: Michael BALL, High Wycombe Buckinghamshire (GB); Nigel EMERY, Monks Risborough Buckinghamshire (GB)

(73) Assignee: VWS (UK) LIMITED, High Wycombe Buckinghamshire (GB)

(21) Appl. No.: 17/908,843

(22) PCT Filed: Apr. 13, 2021
(86) PCT No.: PCT/GB2021/050888

§ 371 Date: Sep. 1, 2022

(30) Foreign Application Priority Data
May 8, 2020 (GB) 2006853.2

(51) Int. Cl. C02F 9/20

(52) U.S. Cl. CPC C02F 9/20; C02F 2103/04

(57) ABSTRACT

There is described a method of treating potable mains feed water to provide a purified water stream of conductivity <20 μS/cm, comprising at least the steps of: (a) providing the potable mains feed water into a first storage tank; (b) circulating the feed water in the first storage tank one or more times through a first purification re-circulation loop including a first capacitive deionisation module in a charging mode to provide a first purified water stream having a conductivity less than the feed water; (c) circulating the first purified water stream one or more times through a second purification re-circulation loop including a second capacitive deionisation module in a charging mode to provide a second purified water stream having a conductivity less than the first purified water stream.

The present invention relates to a method and apparatus for providing ultrapure water, particularly but not exclusively ultrapure medical and laboratory water.

Water purification apparatus for use in laboratories and healthcare facilities are well known. Generally they involve the reduction and/or removal of contaminants and impurities to very low levels from a water source, as well as removing any impurities originating from within the apparatus itself. They typically use a variety of technologies that remove particles, colloids, bacteria, ionic species and organic substances and/or molecules. These technologies typically include; reverse osmosis, micro-filtration, ion exchange, ultrafiltration, adsorption and UV irradiation.

A typical water purification apparatus will have an inlet to provide water to a first purification stage, typically including reverse osmosis, that provides partially purified water into a storage tank. A recirculation loop from the storage tank passes through a second purification stage, typically ion exchange, with the water exiting the second purification stage either being taken from the water purification apparatus as a product water, possibly through a third purification stage at the point of dispense, typically a bacterial filter, or the water exiting the second purification stage is returned to the storage tank. The recirculation of the water helps to maintain the high level of purity required.

The deionising technology used in the first purification stage is usually reverse osmosis. Reverse osmosis uses a membrane with pores of a scale in the range 0.001-0.0001 micron, a scale which is orders of magnitude less than bacteria and viruses and similar to ionic radii of dissolved and hydrated salts. Reverse osmosis membranes require high pressure to be applied to the feed side of the membrane requiring cost in pumping the feedwater to the required pressures. Typically small laboratory water purification apparatus will have a reverse osmosis feed pressure of 4-6 bar with larger laboratory water purification apparatus having a feed pressure of 8-12 bar

Larger, industrial, reverse osmosis membranes can be operated at high recovery, that is around 70% of the feedwater can be recovered as product water. This is achievable by softening the feedwater to the reverse osmosis membranes to exchange hardness forming ions such as calcium and magnesium for high solubility ions such as sodium. This reduces the likelihood of problematic precipitates forming from the salts in the water which will then coat surfaces in the apparatus and can inhibit flow or prevent purification technologies working efficiently. This likelihood is often referred to as the scaling potential and may be enumerated as the Langelier saturation index (LSI).

This method of softening the feedwater is not generally practical for small scale units used in laboratories due to the size of softeners and their need for salt to regenerate the resins. In laboratory water purification apparatus, to maintain a reduced scaling potential, the reverse osmosis module is usually operated with a recovery of around 15%, that is up to 6 times as much water is passed to drain as is passed for further purification. By passing the concentrate from a first reverse osmosis module through a second and potentially a third reverse osmosis module, the water recovery can be increased to around 40% but the pressure requirements and concentrating of the feed to the modules means that the efficiency of the later modules reduces and permeate quality is poorer.

It is an object of the present invention to provide an improved method for the purification of water in laboratory scale water purification apparatus, reducing the pressure required within the apparatus and increasing the water recovery.

According to one aspect of the present invention, there is provided a method of treating potable mains feed water to provide a purified water stream of conductivity <20 μS/cm, comprising at least the steps of:
(a) providing the potable mains feed water into a first storage tank;
(b) circulating the feed water in the first storage tank one or more times through a first purification re-circulation loop including a first capacitive deionisation module in a charging mode to provide a first purified water stream having a conductivity less than the feed water;
(c) circulating the first purified water stream one or more times through a second purification re-circulation loop including a second capacitive deionisation module in a charging mode to provide a second purified water stream having a conductivity less than the first purified water stream.

Potable mains feed water is water typically delivered by municipal or civil, etc. authorities to domestic and industrial locations fit for human consumption. It may be taken from rivers, storage tanks or ground water aquifers, to be part purified in municipal water treatment works before being pumped to domestic and industrial locations. It typically has a conductivity of between 50 and 1000 μS/cm. Ground water typically has higher levels of ‘hardness forming ions’ dissolved in it than water from a surface source.

Water purification methods and apparatus have been developed to remove up to all the ions dissolved in potable mains feed water, so that the conductivity of ‘ultra purified water’ is only a result of the dissociation of water molecules into hydronium and hydroxide ions. The level of dissociation changes with temperature and the conductivity of the ions also changes with temperature, but a standard of 25° C. is usually taken at which the conductivity limit of purified water is 0.055 μS/cm. This value may also be referred to by its resistivity inverse, i.e. a conductivity of 0.055 μS/cm equates to a resistivity of 18.2 MΩ.cm.

As a desired level of purity increases, the cost of the water purification also increases, and the actual purity that a user requires for his operations can be very important. There are national and international bodies, such as the International Organization for Standardization (ISO), which publish standards with different purity requirements, such that for example the ‘ISO3696 Grade 1 water’ requires a resistivity at 25° C. of 10 MΩ.cm, equivalent to 0.1 μS/cm, the ‘Grade 2 water’ requires a resistivity of 1 MΩ.cm, equivalent to 1 μS/cm, and the ‘Grade 3 water’ requires a resistivity of 0.2 MΩ.cm, equivalent to 5 μS/cm.

The term “feed water” as used herein relates to a stream of water intended to be provided into the method and apparatus of the present invention.

The term “feedwater” as used herein is a term for any stream of water to be fed into a module, unit, etc.

The present invention uses capacitive deionisation in first and second capacitive deionisation modules. The first capacitive deionisation module being to provide a first purification of the feed water with the second capacitive deionisation module being to provide a further purification.

Capacitive deionisation (CDI) is a process, which passes a stream of water through one or more pairs of spaced apart electrodes located within a housing forming a CDI module. The electrodes have a high surface area and low electrical resistance thereinbetween. CDI is able to remove ions from the water by ‘capturing’ the ions from the water using electrical attraction towards, and adsorption onto, the surfaces of the electrodes.

Examples of CDI are known in the art, such as those described in U.S. Pat. Nos. 5,192,432 and 5,425,858. Inlet water into a CDI module generally flows between the electrodes, or through the electrodes themselves, or between or around multiple electrodes either located in a module of a single or multiple chambers in the CDI module. These arrangements have different advantages, but they all still relate to providing a purified water stream wherein ions have been removed.

The action of removing ions, including ‘hardness forming ions’, from the water in the CDI module is typically termed ‘charging’, and the operational time therefor is typically termed ‘charging time’. Similarly, the action of subsequently removing the same ions from the CDI electrodes (to allow ion collection elsewhere) is typically termed ‘discharging’, and the operational time therefor is typically termed ‘discharging time’.

Compared with ‘charging’, the electrodes can be discharged relatively quickly by shorting or reversing the direction of the current with further water flow between the electrodes to discharge the so-collected ions from the electrodes into such water, which can then be eluted from the module as a concentrate water stream. Small periods of time may also exist between the charging and discharging for flushing of ions. The collective time for both the charging and the discharging is typically termed the ‘operational time’ (of the CDI or CDI module).

CDI can purify water without the need for oxidation-reduction reactions occurring, as the electrodes electrostatically adsorb and desorb contaminants, typically in the electrodes' macropores and mesopores. During the charging or adsorption part of the cycle, the ions move into the electrodes and the water is purified, while during the discharging or desorption part the ions move out of the electrodes and the water becomes more concentrated.

One particular form of CDI is described in U.S. Pat. No. 6,709,560B2, which describes a combination of CDI electrodes and charge barriers, such as ion-exchange membranes placed in front of one or both of the electrodes, typically both electrodes. The ion-exchange membranes have a high internal charge due to having bound groups such as sulfonate or quaternary amines, which allow easy access for ions of opposite charge to the bound group, either positive or negative (the counter ion) and block access for the ion of the same charge type (the co-ion). They then prevent ions entering the electrodes during discharge. This form of capacitive deionisation is now commonly referred to as ‘membrane capacitive deionisation’ (MCDI).

The use of ion-exchange membranes can significantly improve the performance, in terms of salt adsorption charge efficiency and energy consumption, of the CDI module or CDI process depending upon the ions to be removed.

Conventionally CDI is provided by CDI ‘installations’, that are large in scale, and the amount of water produced by a CDI installation is multiple times higher than that used in laboratories. In these instances, a number of CDI units are used in banks of parallel operation so that some are operated in a charging mode and some are operated in a discharging mode to form a system, which has a feedwater with a constant level of impurities, and a steady flow of product water therefrom, and electrical energy can be recovered. However, this method of operating is unsuitable for the laboratory scale.

CDI electrodes have a capacity for ions that can be represented by the equivalent charge of the ions, i.e. the moles of charge, removed, such that the electrodes of a capacitive deionisation module may have a capacity of X charge equivalents/meter square (eq/m²), and a module with Y m² of electrodes has an overall capacity of X.Y equivalents. For example, a small CDI module may have a membrane area of 0.4 m² and a capacity of the electrodes of 0.05 eq/m² with an overall capacity of 0.02 eq.

Therefore, CDI units have a limit or ‘capacity’ for the amount of ions or ionic charge that may be removed before no more ions can be removed. As their capacity approaches being full, the forces for holding the ions in the electrodes become reduced and the efficiency to capture ions decreases. Thus, it is preferable to set a CDI unit to discharge before they reach 100% capacity. However it is also important not to switch to discharge too early, as this causes water to be passed to drain and so reduce the water recovery of the water purification process. So a balance needs to be made between the charging time and the capacity used for each charge.

Also in order to achieve the highest purity at the end of the purification cycles, the amount of ions held in the electrodes should be limited to maximise the removal of the low level of ions in solution. Therefore optionally, the second CDI module is operated to a lower capacity than the first CDI module, so that the second CDI module maintains its ability to reduce its inlet water to a lower conductivity outlet, resulting in a purer water being able to be dispensed from the apparatus when desired by the user.

In particular, the first and second capacitive deionisation modules may have a predetermined capacity prior to discharge, wherein the second capacitive deionisation module is operated to a lower capacity than the first capacitive deionisation module.

Preferably the first CDI module is charged to >70% of its capacity prior to discharge while the second CDI module is charged to <70% of its capacity prior to its discharge.

As there is a time immediately after switching from charging to discharging where the water in a CDI unit, and in the lines between the CDI unit and the valves, has to be displaced before the discharging effect results in an increased ionic content, it may also be advantageous to operate one or more valves to divert such water to a drain for a short time after the switching to discharging. Similarly, when changing from a CDI unit from discharging to charging, a delay in valve operation will allow for ions in the CDI unit, and between the CDI unit and the valves, to be displaced to a drain.

Optionally, the first purification loop and the second purification loop recirculate from and return to the first storage tank.

Optionally, some of the path of the first purification re-circulation loop is the same as the path of the second purification re-circulation loop. In this way, the first purification re-circulation loop and the second purification re-circulation loop may use the same storage tanks, pump, sensors and valves while using different capacitive deionisation modules and other components.

In one embodiment of the present invention, the method further comprises the steps of:
(d) providing water into a second storage tank;
(e) circulating the water in the second storage tank one or more times through a first concentration re-circulation loop including the first capacitive deionisation module in a discharging mode to provide a first concentrate water stream;
(f) circulating the water in the second storage tank one or more times through a second concentration re-circulation loop including the second capacitive deionisation module in a discharging mode to provide a second concentrate water stream; and,
(g) passing the first concentrate water stream or the second concentrate water stream or both concentrate water streams, to a drain.

Optionally, the first concentration loop and the second concentration loop recirculate from and return to the second storage tank.

Optionally, some of the path of the first concentration re-circulation loop is the same as the path of the second concentration re-circulation loop. In this way, the first concentration re-circulation loop and the second concentration re-circulation loop may use the same storage tanks, pump, sensors and valves while using different capacitive deionisation modules and other components.

Optionally, the method further comprises providing a first purified water stream from the first storage tank to the first concentration re-circulation loop having the first capacitive deionisation module in a discharging mode.

Preferably the first storage tank acts as a reservoir for the water as it is purified during a CDI-charging phase by the first and/or second CDI modules, while the second storage tank acts as a reservoir for the water that is being concentrated during a CDI-discharging phase of the first and/or second CDI modules.

Optionally, the water flows in the first purification recirculation loop, the first concentration recirculation loop, the second purification recirculation loop, and the second concentration recirculation loop, are provided by one pump.

Optionally, the pressure out of the pump and at all points in the recirculation loops is maintained at <2 bar, optionally at <1 bar.

Optionally, the apparatus includes sanitation means to periodically or intermittently sanitise or otherwise clean all of, or at least part of, the apparatus, for example with a sanitising solution such as citric acid.

The present invention can be seen as being based on providing or running one or more sets of first alternating cycles of a first water purification stage comprising step (b) as defined above, and of a first water concentrating stage comprising step (e) as defined above; and providing or running one or more sets of second alternating cycles of a second water purification stage comprising step (c) as defined above, and a second water concentrating stage comprising steps (f) as defined above.

Preferably step (a) is only carried out prior to the first alternating cycle.

Water for the water concentrating stages may be feed water or water taken from the first storage tank.

After one, each, some or all of the water concentrating stages the concentrate water stream may be passed to drain.

After one or some of the water concentrating stages the concentrate water stream may be held in the second storage tank for use in the next water concentrating stage.

In this way, the first alternating cycles provide an initial purification of the feed water to a first level of conductivity, and the second alternating cycles provide more purification of the purified water of the first alternating cycles, to provide a final water having a lower conductivity. Thus, the second alternating cycles further purify or refine the purified water provided by the first alternating cycles.

The first alternating cycles comprise a first water purification stage through the first CDI module to reduce the conductivity of the feedwater provided thereto, followed by ‘cleaning’ of the first CDI module after each purification stage by a first water concentrating stage. The first alternating cycles may comprise one or more sets of first water purification stages and one or more first water concentrating stages, preferably at least 3 to 8 of each stage, optionally more.

Similarly, the second alternating cycles comprise a second water purification stage through the second CDI module to further reduce the conductivity of the feedwater provided thereto, followed by ‘cleaning’ of the second CDI module after each water purification stage by a second water concentrating stage. The second alternating cycles may comprise one or more sets of second water purification stages and one or more second water concentrating stages, preferably at least 3 to 6 of each stage, optionally more.

As the first purification stages and first concentrating stages can be carried out in an alternate fashion, the first alternating cycles can occur over a time period when the provision of a purified water stream is not required. Typically, this may be during hours of no demand such as non-peak hours or ‘night hours’ that occur between the hours of water demand, typically ‘working hours’ or the ‘working day’. In particular, the first and second alternating cycles can occur ‘overnight’ to provide a volume of a purified water stream having the defined conductivity ready for use at the beginning of the subsequent ‘working day’, typically being at a morning hour.

The skilled reader can see that the present invention allows for automated repeated application overnight or during other non-use periods, to provide a purified stream of required conductivity ready for use at the next working requirement.

The first alternating cycles can provide a purified water stream having a target conductivity that may be a pre-determined conductivity or a conductivity that is a proportion of the conductivity of the potable feed water. The second alternating cycles can provide a further purified water having a target conductivity that is a second pre-determined conductivity, being for example <20 μS/cm.

The present invention allows the first and/or second target conductivities or the algorithms to produce them to be set either by a service engineer, or the user, or both. That is, the number of cycles within the first alternating cycle, or the second alternating cycles, or both, and the timing thereinbetween, can be organised to achieve any desired level of conductivity. Sensors, or means to sense a conductivity level, and to determine the achievement of a pre-determined conductivity in or at any part of the present invention, are well known in the art, and are not further described herein.

The present invention also has the flexibility to adapt the timing, number of cycles, size of components, etc. to suit the purity and/or volume of a final purified water stream to be provided from the present invention.

In one embodiment of the present invention, the method of the present invention comprises the steps of:
providing the potable mains feed water into a first storage tank of step (a);
running one or more first alternating cycles of a first water purification stage comprising step (b), and of a first water concentrating stage comprising step (e);
passing the first concentrate water stream to a drain;
optionally providing water in the first storage tank into the second storage tank before one or both of the first and second water concentrating stages;
running one or more second alternating cycles of a second water purification stage comprising step (c), and a second water concentrating stage comprising steps (f); and
passing the second concentrate water stream to a drain of step (g).

Optionally, the one or more first alternating cycles provide a purified water stream of conductivity <400 μS/cm, or <300 μS/cm, or <200 μS/cm or <100 μS/cm, or <50 μS/cm.

Optionally, the one or more first alternating cycles provide a purified water stream of conductivity which is <40%, <30%, <20% or <10% of the conductivity of the potable feed water to the water purification apparatus.

The skilled reader can see that the conductivity of the first purified water stream can be tuned to any suitable pre-determined value or proportion based on suitable measurement of the conductivity of the first purified water, optionally in the first purification re-circulation loop or in the first storage tank.

Optionally, the first and second cycles occur over at least 3, 4, 5, 6, 7, 8, 9, 10, 11, 12 hours or more. This may occur ‘overnight’ or over another period of non-requirement for a purified water stream.

Optionally, the first and second cycles occur over less than 12, 11, 10, 9, 8, 7, 6 hours.

Optionally, the first alternating cycles occur at least three times each.

Optionally, the method of the present invention can provide a purified water stream of conductivity <10 μS/cm, or <5 μS/cm, or <1 μS/cm, or lower.

Optionally, the present invention further comprises passing water through an electrodeionisation device or module prior to the dispense. Electrodeionisation (EDI) applies an electric field across an ion exchange resin bed and uses ion-selective membranes to remove ionised and ionisable species from water. Water passes through one or more chambers filled with ion exchange resins held between cation and anion selective membranes, The ions in solution are exchanged for hydroxide or hydrogen ions on the resins thus creating deionised water. The unwanted ions then migrate under the influence of an electric field through the ion exchange resins and ion selective membranes into separate concentrate chambers, and from there can be flushed out of the electrodeionisation device.

Typically, the EDI chambers are arranged in the form of a “stack” between the two main electrodes. The amount of ions that can be removed is a function of the applied electrical current and so the stack can easily be overloaded if there are high levels of salts or other ionic or ionisable species in the water stream. Particulate and organic fouling can also reduce the performance of the stack. EDI stacks are particularly susceptible to the formation of a hardness scale on the membranes, formed by the precipitation of sparingly soluble salts of ‘hardness forming ions’, such as calcium or magnesium. This necessitates that the feedwater to the EDI has to have a very low level of such dissolved hardness forming ions to maintain proper functioning. A typical specification requirement for an EDI unit such as the Evoqua Ionpure LX is <1 ppm as CaCO₃, which equates to 0.4 ppm of calcium in the feedwater inlet to the EDI.

Thus, it is typical for water that is intended to be purified to the highest levels achievable by EDI, to be ‘pre-conditioned’ or ‘pre-treated’. Previously this pre-treatment has included at least reverse osmosis, to remove the majority of the ionic contaminants. A conventional softening treatment pre or post the reverse osmosis by ion exchange material in the sodium form has been used to remove more or remaining hardness forming ions.

As feedwater into the EDI module in the present invention is already at a high purity, the EDI module for the present invention may have only 3 or 5 chambers in its stack, such that it has only one chamber for removing anions using anion exchange resin, and one for removing cations using cation exchange resin, or one for removing both anions and cations in a mixed resin chamber.

Optionally, the EDI module may be located in a third water purification re-circulation loop formed or extending from the first storage tank, such that recirculating the water in the first storage tank through the EDI module purifies the water stored in the first storage tank. The third water purification re-circulation loop may share significant parts of the loop with the second water purification re-circulation loop. Alternatively the EDI module may be positioned in a dispense line from the water purification apparatus using the method of the present invention.

The EDI module may be powered continuously or intermittently during water purification thereby moving the ions removed by the ion exchange resin into the concentrate chamber and may be flushed continuously or intermittently with a concentrate flow generating a concentrate stream, Alternatively the EDI module may be powered during a specific regeneration mode that may be operated periodically after a number of operation cycles. In the latter case concentrate water will only be generated from the EDI module during this specific regeneration cycle.

Optionally, the use of an EDI module in the present invention can provide a purified water stream of conductivity <0.5 μS/cm, or <0.2 μS/cm, or <0.1 μS/cm.

Silica may also be present in the potable feedwater. But silica has a very low dissociation constant, so that it is very poorly removed by using CDI. Thus the additional involvement of an EDI module can ionise and remove the amount of silica in a final purified dispense water stream, such that the amount of silica in the dispense water stream may be <5 wt %, preferably <1 wt % or <0.1 wt % of the amount of silica in the potable feedwater.

Optionally, the method further comprises passing water through a degassing membrane. Carbon dioxide removal may be assisted by the use of a degassing membrane, optionally sited in the second water purification re-circulation loop, the third water purification re-circulation loop, or a combined section of the two. Degassing membranes are known in the art and use a vacuum, gas or air flow on one side of a membrane that can pass carbon dioxide or other gases through it such that the gas passes from a liquid flowing on the other side of the membrane into the vacuum or gas flow. Degassing membranes have a high membrane area and will typically reduce the amount of carbon dioxide in a liquid but will not remove all of it. Thereby they reduce the amount of carbon dioxide that needs to be removed by other processes but these processes are still required to purify water to a conductivity of <0.5 μS/cm or resistivity of >2MΩ.cm.

Optionally the water purification apparatus may contain complementary purification technology to remove non ionic contaminants such as chlorine, bacteria and particles. Chlorine may be removed by for example activated carbon as known in the art. Bacteria may be inactivated using an ultra-violet irradiation device, preferably a UV LED disinfection device, installed in one or more of the recirculation loops or in the dispense conduits. Larger particles may be removed by strainers or filters on the inlet. Smaller particles, including bacteria, may be removed by point of use devices, sited where the purified water is dispensed from the apparatus.

Optionally, a degassing membrane can be located in the second purification re-circulation loop, a third purification re-circulation loop, or a combined section of the two.

It has been found that the present invention can produce a volume of purified water of conductivity <20 μS/cm that is >50%, preferably >70% or >80%, of the volume of potable mains feed water provided into the first storage tank.

This level of water ‘recovery’ (purified water product produced compared to potable feedwater input) is a dramatic increase for laboratory scale water purification apparatus, higher than typically achievable with a laboratory scale reverse osmosis and avoids the need for a reverse osmosis module with its attendant high pressures, CAPEX and OPEX.

According to a second aspect of the present invention, there is provided a water purification apparatus able to provide a purified water stream of conductivity <20 μS/cm from a potable main feed water, comprising:
an inlet for potable water;
a first storage tank;
a pump;
a first purification recirculation loop from the first storage tank through a first capacitive deionisation module in a charging mode and returning to the first storage tank;
a second storage tank;
a first concentration recirculation loop from the second storage tank through the first capacitive deionisation module in a discharging mode and returning to the second storage tank;
a second purification recirculation loop from the first storage tank through a second capacitive deionisation module in a charging mode and returning to the first storage tank;
a second concentration loop from the second storage tank through the second capacitive deionisation module in a discharging mode and returning to the second storage tank;
an outlet for purified water.

Optionally, the water purification apparatus is constructed in a single chassis or frame, with a housing or covers so that it is viewed as one complete unit that may be located on or under a laboratory bench or mounted on a laboratory wall, and only requires connection to a source of potable water, drain and power.

Preferably the first storage tank acts as a reservoir for the water as it is purified during a charging phase by the first and/or second CDI modules, while the second storage tank acts as a reservoir for the water that is being concentrated during the discharging phase of the first and/or second CDI modules.

Optionally, the first storage tank is designed to hold an amount of water that when purified, preferably overnight, will be used in a laboratory during a typical working day plus an amount of water to be transferred to the second storage tank during the purification process.

Optionally, the working volume of the second storage tank should be equal to or less than 10% of the first storage tank. For example, the total working volume for water of the first storage tank could be less than 25 litres, preferably less than 20 litres, while the total working volume for water of the second storage tank could be less than 2 litres, preferably less than 1 litre.

Preferably the potable mains feed water to be purified enters the water purification apparatus, either directly or indirectly, into a first storage tank from which it recirculated through the first capacitive deionisation module in a charging mode until the used capacity of the first capacitive deionisation module is >70% and the conductivity of this first purified water has been reduced by a proportional amount as would be shown by a mass balance of the ions in the system.

At a suitable stage, potable mains feed water is also taken into a second tank as a ‘concentrate water stream’, and such water is then recirculated as a concentrate stream through the first capacitive deionisation module when in a discharging mode, such that the ions collected in the first capacitive deionisation module during charging enter the concentrate water, increasing its conductivity in line with a mass balance of the ions in the recirculation loop. When most or approaching all of the ions have been removed from the first capacitive deionisation module, the concentrate stream can be diverted to drain and out of the water purification apparatus.

The first capacitive deionisation module is now ready to accept more charge from the first purified water in the first storage tank, and this water is again recirculated through the first capacitive deionisation module in a charging mode, further reducing the ionic content and conductivity of the first purified water.

This charging stage and discharging stage can be repeated as a ‘first alternating cycles’ until the conductivity of the first purified water reaches a desired conductivity or ionic content. During this period it is preferable for the concentrate stream in the second storage tank to include a fresh amount or portion of potable mains feed water for each discharge cycle, but as the first purified water becomes purer, it may additionally or alternatively be possible to take a quantity of the first purified water as the water to be used in the concentrate stream. In this case, water can be taken from the first storage tank, passed through the first capacitive deionisation module and diverted to the second storage tank, prior to its recirculation therefrom through the first capacitive deionisation module in its discharging mode.

Starting with a lower conductivity in the concentrate stream allows the concentrate stream to operate with less water and still be operated to the same concentration at the end of the discharging process. Alternatively if the same amount of concentrate water is used, then a lower concentration and hence lower scaling potential, can be reached in the concentrate water.

If the scaling potential of the concentrate water at the end of the discharge is high, then periodic or occasional recirculation of a suitable solution to remove scale, such as citric acid, from the concentration loop may be initiated.

After a set amount of charging and discharging cycles, or after the first purified water has reached a desired conductivity or ionic content, or proportion of the initial feedwater conductivity, then a suitable selector, valve or other valving allows the first purified water to be passed to and through the second capacitive deionisation module for increased purification. The second capacitive deionisation module can be operated in the same manner with charging and discharging cycles as the first capacitive deionisation module, and passes the water being purified to the first storage tank as a second purified water.

Optionally, during operation of the second capacitive deionisation module, the capacity of the second capacitive deionisation module is preferably used to a lesser extent than was used during operation of the first capacitive deionisation module, such that for example <70% of the capacity is used each charging cycle.

The second capacitive deionisation module may be the same size as the first capacitive deionisation module or it may be smaller than the first capacitive deionisation module, such as having 50% of the electrode area of the first capacitive deionisation module as it needs to remove less ions.

Optionally, during operation of the second capacitive deionisation module, no new or fresh mains feed water is taken into the water purification apparatus, and water for the discharging cycle is taken from a portion of the second purified water into the second storage tank to act as the concentrate stream.

As the purification proceeds through its cycles, the amount of ions removed each purification or charging stage or cycle reduces, and so the concentration of the water during the concentrating or discharge stage or cycle becomes reduced, and it becomes possible to operate more than one discharge cycle with the same concentrate water, thus reducing the water that passes to drain and increases the water recovery of the water purification apparatus.

By repeated charging and discharging cycles, the second purified water becomes successively purified until the conductivity of the second purified water reaches a desired conductivity or ionic content, typically <10 μS/cm. although higher limits can be used if that is what the operator desires.

Thus, even with high conductivity potable main feeds water, the amount of water that is passed to drain during the purification process of the present invention can be <50% of the amount of water entering the apparatus, and the water recovery is therefore >50%, significantly higher than occurs with conventional reverse osmosis based laboratory water purification units.

Where the potable mains feed water is of relative low conductivity, the amount of purification cycles that may be required can be reduced even further, so that the amount of water that may be passed to drain during the purification process of the present invention may be <30%, or <20% of the amount of water entering the apparatus, and the water recovery is therefore >70% or >80%.

Carbon dioxide dissolves in water from the air and has to be removed if the water is to reach a conductivity of <1 μS/cm. Although capacitive deionisation is a good purifier of strongly ionised or dissociated ions in water, it is poor at removing weakly ionisable molecules such as silica and carbon dioxide. Alternative processes are able to remove weakly ionisable molecules, one such alternative process is electrodeionisation.

In another embodiment of the invention, the second purified water is passed through an electrodeionisation device or module prior to its dispense from the water purification apparatus.

Optionally, the apparatus further comprises a recirculation pump to recirculate water around the recirculation loops within the apparatus.

Optionally, the apparatus is locatable on or under a laboratory bench or mounted on a laboratory wall.

Optionally, the apparatus further comprises an electrodeionisation device or module prior to the dispense from the water purification apparatus.

Optionally, the apparatus further comprises a degassing membrane.

Optionally, the apparatus further comprises one or more sensors to measure the conductivity of water in the first purification recirculation loop, or in the an outlet for purified water, or both.

Optionally, the apparatus further comprises one or more control to control the flow of water in one or more of the group comprising: the first purification recirculation loop, the second purification recirculation loop, the first concentration recirculation loop, and the second concentration recirculation loop.

Optionally the water purification apparatus may contain complementary purification technology to remove non ionic contaminants such as chlorine, bacteria and particles. Chlorine may be removed by for example activated carbon as known in the art. Bacteria may be inactivated using an ultra-violet irradiation device, preferably a UV LED disinfection device, installed in one or more of the recirculation loops or in the dispense conduits. Larger particles may be removed by strainers or filters on the inlet. Smaller particles, including bacteria, may be removed by point of use devices, sited where the purified water is dispensed from the apparatus.

The water purification apparatus includes electronic controls required to operate the apparatus. This will include one or more microprocessors typically located on one or more printed circuit boards but a programmable logic controller could alternatively be used. The electronic controls also include inputs and outputs to devices such as sensors, valves and pumps within the apparatus and may link to components or management systems outside the water purification apparatus.

Optionally, level control apparatus in the storage tanks can be used to stop and start the unit operations as well as providing information to the operator.

Optionally, the water treatment method or apparatus comprises one or more sensors, such as flow sensors to monitor one or more parameters, or water quality sensors, such as conductivity measurement devices or specific ion determination sensors.

The present invention may use different sensors at different locations within the apparatus and reference them at different stages of the method.

Optionally, the present invention uses one or more water quality sensors, typically in advance of, or following discharge from, or both, of one or more of the different stages of the method or purification technologies in the apparatus.

In one embodiment, the apparatus and method includes one or more water quality sensors, and data from the one or more sensors is used to control the voltage or current applied to the capacitive deionisation unit or to instigate the switching of the cycle from charging to discharging.

In another embodiment, the apparatus and method includes one or more water quality sensors, and data from the one or more sensors is used to control whether either the first capacitive deionisation module or the second capacitive deionisation module is used in that particular cycle.

As the water discharged to drain from the later purification cycles is typically purer than the original potable water that is being purified, the water from the later CDI discharge cycles or the EDI concentrate may be retained within the apparatus, optionally in a third storage tank, for use as part of the feedwater for the next fresh purification operation. This reduces the amount of feedwater required, hence improving the water recovery and reduces the power requirements of that subsequent purification.

Preferably the apparatus and method includes an input device such as a touchscreen, buttons or other form as known in the art. The user of the apparatus of the invention may be able to input requirements for their application such as the desired water purity, i.e. conductivity or resistivity they require.

The user may also input environmental requirements such as the level of water ‘recovery’ (purified water output volume compared to feedwater input volume) that is required. This may be necessary for environmental regulations or reporting for the facility. The apparatus may then be able to determine the water purity that may be obtained while meeting those environmental limits, or could modify its program, such as concentrating the water by repeat concentrate re-circulations prior to enacting a discharge while still meeting desired water purity requirements.

The user may also input if the potable mains feed water is low in hardness forming ions, such as if the site has a softener for other applications whose supply can be used to feed the water purification apparatus of the present invention. The control system of the unit can then modify the cycles to allow higher concentration of concentrate water and further increase the water recovery of the apparatus.

Thus, in a further aspect of the invention, there is provided a method of operating a laboratory water purification apparatus as defined herein and able to provide water of <10 μS/cm, comprising the step of user-selection of the purity of water to be provided.

In this way the user may specify a reduced purity of water for a day that they will only be having general laboratory water activities such as glass washing or dilution but on days that higher purity operations such as operating analytical equipment are planned may select a higher purity. The control system of the apparatus may then modify its operation such that the number of purification cycles may be reduced, EDI may not be used and/or water discharge times may be altered.

The apparatus may also include an electrodeionisation module and/or a degassing module and/or a UV LED device.

The apparatus and method of the current invention is expected to make up a batch of water overnight and for that water to be used during the daytime operation of a laboratory. Thereby the make up time of the method and apparatus is <12 hours while the use time is typically up to the remaining period of the day.

If the laboratory is operated 24 hours a day, then the apparatus and method could be modified with either a second first storage tank or a second pair of first and second storage tanks, to allow daytime and night-time purification while holding purified water in the first storage tank available for use. Alternatively, the first storage tank could transfer the purified water to a third tank to hold the final purified water. The invention therefore includes embodiments with more than two tanks.

Embodiments of the present invention will now be described by way of example only, and with reference to the accompany drawings in which:

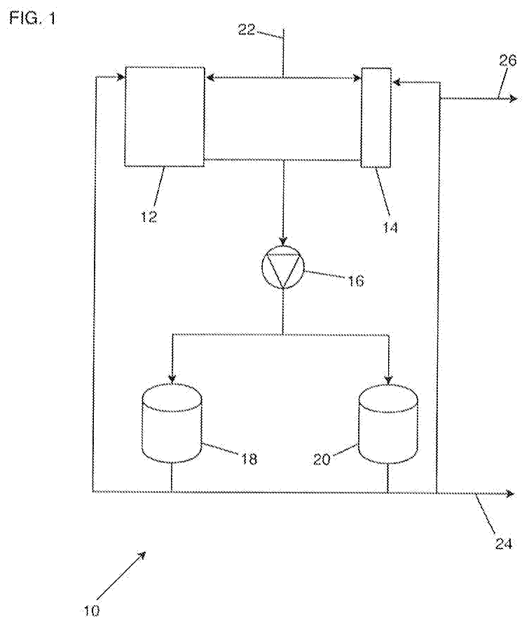

FIG. 1 is a schematic of a first embodiment of the invention;

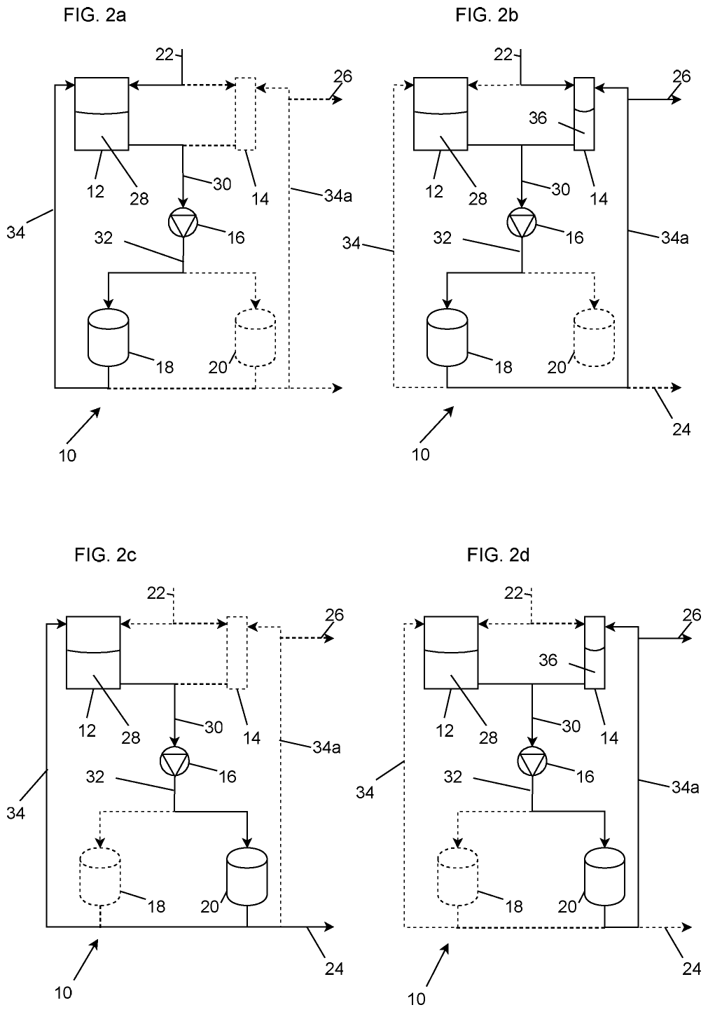

FIGS. 2a-d are a series of schematics showing operation of the first embodiment of the invention:

FIG. 2a being a first purification stage based on the first capacitive deionisation module in a charging mode,

FIG. 2b being a first concentrating stage based on the first capacitive deionisation module in a discharging mode,

FIG. 2c being a second purification stage based on the second capacitive deionisation module in a charging mode; and

FIG. 2d being a second concentrating stage based on the second capacitive deionisation module in a discharging mode;

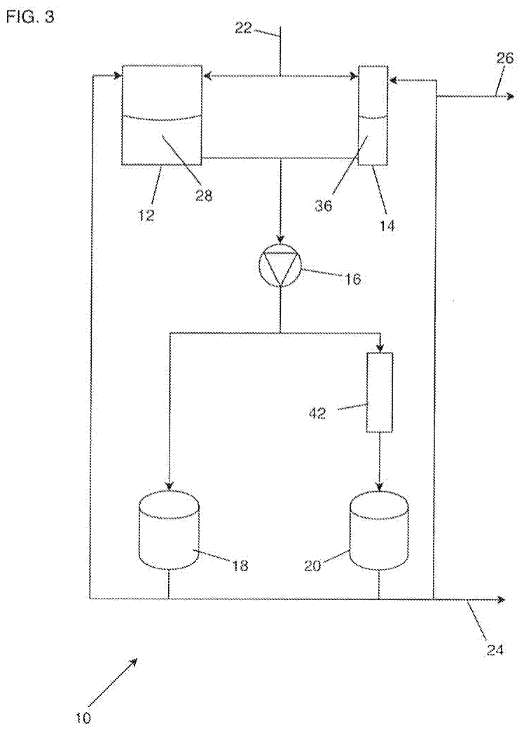

FIG. 3 is a schematic of the first embodiment of the invention with the addition of a degassing membrane in the feed to the second capacitive deionisation module;

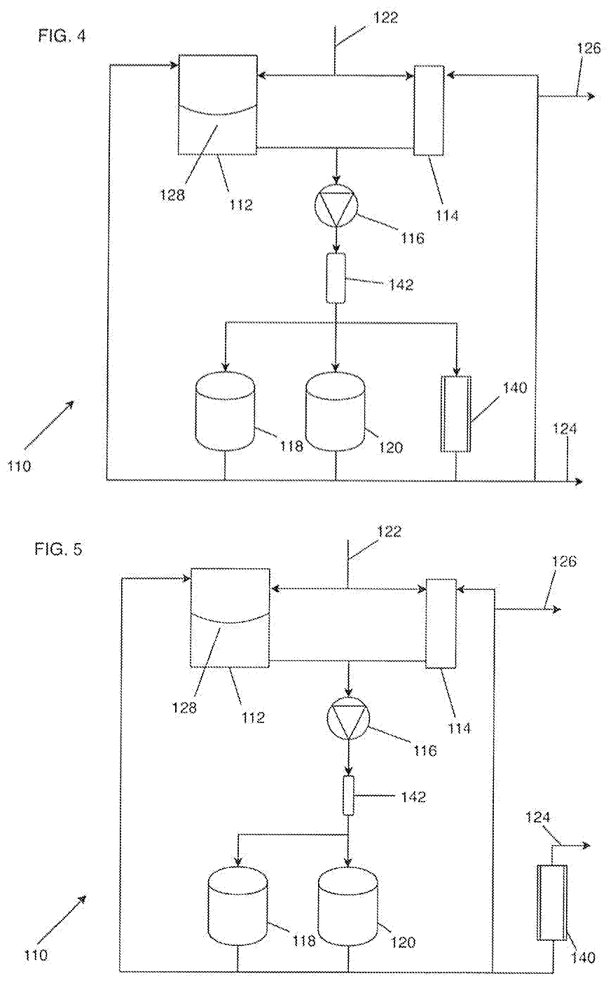

FIG. 4 is a schematic of a second embodiment of the invention;

FIG. 5 is a schematic of a third embodiment of the invention, and

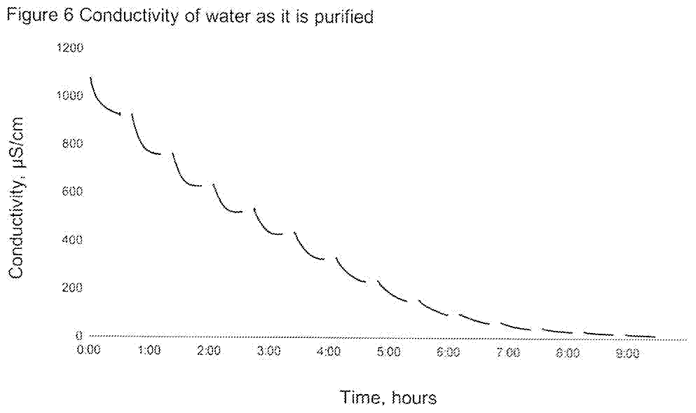

FIGS. 6, 7 and 8 are graphical representations of changes in water purity with repeating cycles of the present invention.

Referring to the drawings, FIG. 1 shows a water purification apparatus 10, incorporating a first storage tank 12, a second storage tank 14, a pump 16, a first capacitive deionisation (CDI) module 18 and a second capacitive deionisation module 20.

The storage tanks, pumps and CDI modules are connected by tubes, pipes or conduits as known in the art, and indicated by the lines in the accompanying FIGS. 1-5. Operation of the water purification apparatus 10, takes place by a controller such as a microprocessor or programmable logic controller (PLC, not shown). The controller is connected to the pump 16 and such 2-way or 3-way valves as required to cause the water to flow in the tubes, pipes and conduits as necessary to allow the processes described hereafter to take place.

The water purification apparatus has a feed water inlet conduit 22, which can be connected to any suitable potable mains source of water to be purified, preferably a potable source as supplied by a local water authority. The apparatus also has a product water outlet conduit 24 for the dispense of the purified water at a suitable point of use by a use, and a concentrate water outlet conduit 26 for the removal of wastewater (containing the ions removed) from the apparatus 10.

FIGS. 2a-d show the operation of the apparatus based on different stages and cycles of a method of the present invention. Those water pathways and components of FIG. 1 used in each stage or cycle are retained in full for clarity. FIG. 2a shows a charging stage of the first CDI 18 as part of a first purification re-circulation loop; FIG. 2b shows a discharging stage of the first CDI 18 as part of a first concentrating re-circulation loop; FIG. 2c shows a charging stage of the second CDI 20 as part of a second purification recirculation loop; and FIG. 2d shows a discharging stage of the second CDI 20 as part of a second concentrating re-circulation loop.

FIG. 2a shows the steps of providing the potable mains feed water into a first storage tank 12, and circulating the feed water in the first storage tank one or more times through a first purification re-circulation loop including a first capacitive deionisation module 18 in a charging mode to provide a first purified water stream having a conductivity less than the feed water. The feed water enters the storage tank 12 such that there is a volume of water 28 in first storage tank 12. The amount of water in first storage tank 12 may be determined by a level sensor, mass or pressure measurements or determined by flow measurements in the conduit(s), all as known in the art.

The water 28 then passes from first storage tank 12 into pump 16 via pump feed conduit and suitable valving, and into first CDI module 18 via first CDI module feed conduit 32 and suitable valving. In the first CDI module 18 voltage is applied across the electrodes and ions are drawn into the electrodes such that the water leaving the first CDI module 18 has less ions therein than were in the water entering it, i.e. that it has become partially purified. This partially purified water is then returned to the first storage tank 12 via recirculation conduit 34 and suitable valving to complete the first purification re-circulation loop (12, 30, 16, 32, 18, 34), and to complete one circulation of multiple circulations as a first purification stage. As the recirculation from the first storage tank 12 through the first CDI module 18 in a charging mode proceeds, some of the ions that were in the volume of water 28 in first storage tank 12 are taken up by the electrodes of the first CDI module 18, and the conductivity of the water 28 in the first storage tank 12 reduces.

The first purification stage can continue for a pre-determined time, or until the water reaches a pre-determined purity. Alternatively or additionally, as the capacity of the electrodes of the first CDI module 18 for ions is limited, there may be a point when no further ions can be taken up on the electrodes, or the efficiency of that take up becomes reduced.

The apparatus then initiates a first concentrating stage, circulating water in the second storage tank 14 one or more times through a first concentration re-circulation loop including the first capacitive deionisation module 18 in a discharging mode, to provide a first concentrate water stream which can be passed to a drain 26 as shown in FIG. 2b.

In FIG. 2b, water in the recirculation conduit 34 can be temporarily diverted by suitable valving to the second storage tank 14, until the amount of water 36 in the second storage tank 14 reaches a desired quantity. Desirably, the amount of water 36 in second storage tank 14 is much smaller than the amount of water 28 in first storage tank 12. Alternatively or additionally, a fresh quantity of feedwater is passed directly into second storage tank 14 from the feed water inlet conduit 22. This arrangement can be preferable while operating the first alternating cycles of the present invention.

Once the second storage tank 14 has the desired amount of water 36 therein, the feed to the pump 16 is changed such that it comes from the second storage tank 14. The water 36 in the second storage tank is passed by pump 16 into the first CDI module 18 and back to the second storage tank by conduits 30, 32 and 34a forming a first concentrating loop (14, 30, 16, 32, 18, 34a) with suitable valving, and to complete one circulation of multiple circulations as a water concentrating stage. The first CDI module 18 is operated in discharge mode. The discharge mode is usually a reversal of the direction of current that was used during the charging mode. Ions on the electrodes pass into the water as it passes through the first CDI module 18 such that the ionic content of the water leaving the first CDI module is greater than that entering the first CDI module 18. As the water 36 in the second storage tank 14 is recirculated in this manner, its ionic content and conductivity increase.

As the electrodes of the first CDI module 18 become exhausted of ions, the increase in conductivity, monitored by a suitable sensor, reduces or stops. Operation of valves then cause the water exiting the first CDI module 18 to be passed out of the water purification apparatus 10 via a concentrate outlet conduit or drain 26 to complete the first concentrating stage.

This charging and discharging modes of the first CDI module 18 constitutes one first alternating cycle of the first CDI module 18. By means of the first cycle, ions that were in the water 28 in the first storage tank 12 are ultimately removed from the water purification apparatus 10 in a small amount of concentrate water. The remaining water 28 in the first storage tank 12 is purer, i.e. of a lower ionic content and conductivity than prior to the first cycle.

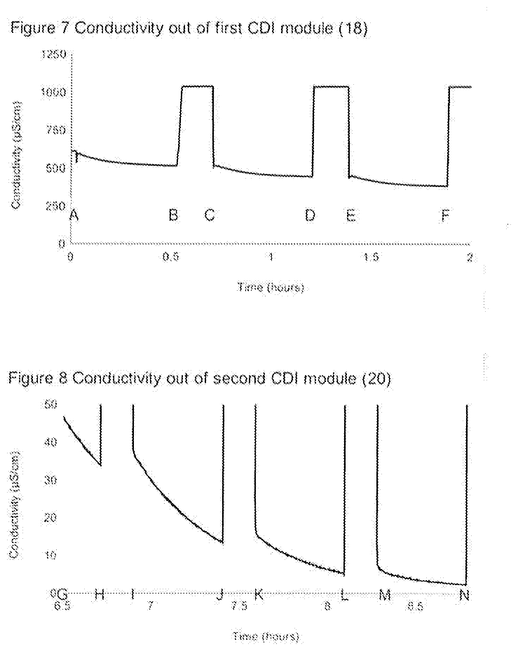

By repeating the first alternating cycles of the first water purification stage and the first water concentrating stage, the ionic content of the water 28 in the first storage tank can be sequentially lowered. An example of the pattern of the lowering of the water conductivity is shown in FIG. 7, discussed further hereafter.

As the purity of the water 28 in the first storage tank increases, the purification quality of the first CDI module 18 becomes limiting. To be able to reach a lower final product water conductivity a second CDI module is used.

FIGS. 2c and 2d show operation of a charge and discharge cycle of the second CDI module 20. In particular, FIG. 2c shows a second water purification stage based on circulating the first purified water stream one or more times through a second purification re-circulation loop (12, 30, 16, 32, 20, 34) including the second capacitive deionisation module 20 in a charging mode to provide a second purified water stream having a conductivity less than the first purified water stream. FIG. 2d shows a second concentrating stage based on circulating the water in the second storage tank 14 one or more times through a second concentration re-circulation loop (14, 30, 16, 32, 20, 34a) including the second capacitive deionisation module 20 in a discharging mode to provide a second concentrate water stream.

Together, FIGS. 2c and 2d show a second alternating cycle of the present invention. The cycles occur in a similar manner to that described above for the first CDI module 18.

The second purification stage starts with recirculation of water 28 from the first storage tank 12 and charging within the second CDI module 20, removing ions from the water 28. Once the second CDI module 20 charging becomes reduced or the second CDI module is close to capacity, a small amount of water is passed from first storage tank 12 to the second storage tank 14, and the water 36 in the second storage tank is then recirculated through the second CDI module 20 now set to be in a discharging mode, before the so-formed second concentrate stream, having the ions expelled from the second CDI module 20, is passed out of the water purification apparatus via the discharge conduit or drain 26.

When the water 28 in the first storage tank 12 has become of a pre-determined purity quality, the water in the first storage tank 12 is ready for use by a user. The water can be discharged via a product water outlet conduit 24 to a suitable point of use as known in the art.

FIG. 3 shows the first embodiment of the invention with the addition of a degassing membrane 42 in the conduit to the second capacitive deionisation module 20. Degassing membranes are known in the art and are able to remove dissolved carbon dioxide from water passing through them. The carbon dioxide is transported from the water across a membrane into an exhaust gas or vacuum in a manner known in the art.

FIG. 4 shows a second embodiment of the present invention. The second water purification apparatus 110 shares all the features of the first water purification apparatus 10 shown in FIG. 1, i.e. a first storage tank 112, a second storage tank 114, a pump 116, a first CDI module 118, a second CDI module 120, a feedwater conduit 122, a product water conduit 124, and a discharge conduit 126, along with the recirculation conduits as defined above.

The second water purification apparatus 110 includes a third water purification device 140 able to remove both strongly ionised impurities and weakly ionised impurities such as dissolved carbon dioxide or silica, so that the water purity can reach a conductivity of <1 μS/cm, preferably <0.1 μS/cm, and possibly approaching the maximum level of ionic purity of water of 0.055 μS/cm. One such water purification device is an electrodeionisation module.

The second water purification apparatus 110 may further include a degassing membrane 142. The degassing membrane is shown in a combined conduit from the pump 118, but may be located in one or all of the conduits into the first CDI module 118, the second CDI module 120, or the third water purification device 140. As the degassing membrane has greater effect the higher the water purity, it is preferably located in at least one of the conduit for the second CDI module 120 and the third water purification device 140.

The second water purification apparatus 110 is operated with the same first and second alternating cycles of water through the first and second CDI modules 118, 120, the first and second CD1 modules 118, 120 being operated in the same charging and discharging modes as discussed above, until the water 128 in the first storage tank 112 has reached a pre-determined or desired water purity, preferably being a conductivity of <10 μS/cm, more preferably <5 μS/cm.

The water is then recirculated around the third water purification device 140 where the ions, including weakly ionised molecules, are removed from the recirculating water. In this way the water in the first storage tank 112 can further increase the water purity to a conductivity of <1 μS/cm.

FIG. 5 shows an alternative arrangement of the components in FIG. 4, with the third water purification device 140 located in the conduit from the second CDI module 120 to the product water conduit 124.

Where the third water purification device 140 is an electrodeionisation device, it may be operated either with power applied during purification to create a concentrate stream, or with a separate discharging mode, which discharging mode may be applied after a set time of operation, or after a set amount of ions have been removed, or based on a decrease in performance.

FIGS. 6, 7 and 8 show conductivity data from a method of operation and apparatus as shown in FIG. 3 based on the following Examples.

### Example 1

An apparatus as shown in FIG. 3, with first and second capacitive deionisation modules 18, of capacity of 17 meq each, was operated to purify 19.3 litre of feed water of conductivity of 1070 μS/cm taken into the first storage tank 12. Water was recirculated by the pump 16 at 1 litre per minute, and the pressure out of the pump 16 was 0.5 bar.

FIG. 6 shows how the conductivity of the water in the first storage tank 12 decreased during operation of the water purification apparatus 10.

The first purification stage based on the first purification recirculation loop through the first CDI module 18 in a charging mode (as shown in FIG. 2a) lasted ½ hour or 30 minutes, and resulted in the conductivity of the water in the first storage tank decreasing to 923 μS/cm.

There was then a first concentrating stage based on the first concentrating recirculation loop through the first CDI module 18 in a discharging mode (as shown in FIG. 2b) lasting 12 minutes, (and shown as a gap in the conductivity line in FIG. 6), to complete a first alternating set of these first stages.

Another or a second first purification stage based on the first purification recirculation loop through the first CDI module 18 in a charging mode lasted for another ½ hour period to reduce the conductivity of the water in the first storage tank 12 down to 757 μS/cm. This was followed by a second concentrating stage (based on the first concentrating recirculation loop through the first CDI module 18 in a discharging mode, and shown as a second gap in FIG. 6) to complete a second alternating set of the first cycles.

After eight sets of these first alternating cycles, the water in the first water storage tank 12 was then purified using the second CDI module 20 in the manner of six sets of second alternating cycles of the second purification stage based on the second purification recirculation loop through the second CDI module 20 in a charging mode (as shown in FIG. 2c) lasting ½ hour or minutes each time, and then a second concentrating stage (based on the second concentrating recirculation loop through the second CDI module in a discharging mode (as shown in FIG. 2d) lasting 12 minutes each time, (and shown each time as a gap in the conductivity line in FIG. 6.

FIG. 6 shows these fourteen sets of the first and subsequent second alternating cycles, reducing the conductivity of the water in the first storage tank to 11 μS/cm, (and with water of conductivity of 5 μS/cm exiting the second CDI module 20). For each of the first four first concentrating stages, 680 ml of potable feed water was taken into the second storage tank 14 to be used for the concentrate stream to the first CDI module 18, while for the other ten (first and second) concentrating stages, the 680 ml of concentrate water 36 was based on using the partially purified water 28 in the first storage tank 12 taken into the second storage tank 14, (from where it was recirculated around the relevant capacitive deionisation module depending on the cycle).

At the end of purification 12.5 litres of water was available for dispense, being 57% of the total water taken into the apparatus.

### Example 2

FIG. 7 shows how water exiting a first CDI module during three first purification stages and two alternating first concentration stages, varied over a first 2 hours of using the present invention using another feed water.

The water purification apparatus used was the same as in Example 1 and as shown in FIG. 3. The apparatus was operated with an initial 19.3 litres of feed water, which initially had an ionic contamination which caused a conductivity of 610 μS/cm, (time A in FIG. 7). This feed water was recirculated by a pump in a first purification stage as shown in FIG. 2a at 1 litre per minute, with 0.5 bar pressure from the pump 16.

As the ions in the water 28 were removed in the first CDI module 18 running in a charging mode, the conductivity of the water 28 recirculating around the first purification loop reduced, until the first CDI module 18 was becoming saturated with ions, such that at time B in FIG. 7, the first CDI module 18 was changed to discharging mode to start the first concentrating stage as shown in 2b and described above. Preferably this change occurs after the first CDI module 20 reaches a high capacity, e.g >70%, so that most of its capacity has been used. It may be initiated on a time basis or as an integration of ions removed.

At time B, 700 ml of feed water was taken into the unit to use as concentrate water 36, and this was recirculated through the first CDI module 18, and the first CDI module 18 was discharged of the ions taken up on the electrodes during charging to reach time C. At time C, the concentrate water was discharged from the water purification apparatus 10 via the discharge conduit 26, and the next first purification stage (as shown in FIG. 2a and described above), was initiated. As the first purification/charging and concentrating/discharging cycles alternately continued, the ionic content of the water 28 in the first storage tank 12 was reduced, such that it became 515 μS/cm at point B, 446 μS/cm at point D, and 327 μS/cm at point F.

The cycles continued in this manner reducing the conductivity of the water 28 through each cycle. After the first four cycles, the 700 ml of concentrate water was taken from the first storage tank 12 into the second storage tank 14 as described above. After the eighth charge and discharge cycles using the first CDI module 18, the second CDI module 20 was used.

FIG. 8 shows how the conductivity of the water starting from FIG. 7 and now exiting the second CDI module varied between the times of 6.5 hours to 8.8 hours, and based on the tenth to thirteenth second alternating cycles.

After 6.5 hours of treatment, time G, the water 28 in the first storage tank 12 being fed to the second CDI module 20 had an ionic contamination which resulted in a conductivity of 46 μS/cm. This water underwent another second purification stage (i.e. recirculated as in FIG. 2c), whilst also being passed through a degassing membrane as shown in FIG. 3 before the second CDI module 20. As the ions in the water 28 were removed in the second CDI module 20, the conductivity of the water 28 recirculating around the system reduced to time H. At time H in FIG. 8, the second CDI module was switched to a discharging mode to start another second concentrating stage. Preferably this occurs before the second CDI module 20 reaches a high capacity, e.g <70%, so that it can be discharged effectively and may be initiated on a time basis or as an integration of ions removed.

Concentrate water 36 was recirculated as per FIG. 2d, and the second CDI module 20 was discharged of the ions taken up on the electrodes (shown as a gap in the conductivity in FIG. 8 until at time I). At time I, the concentrate water was discharged from the water purification apparatus 10 via discharge conduit 26, and the next purification charging stage (as shown in FIG. 2c and described above) was initiated.

As the charging and discharging cycles continued, the ionic content of the water 28 in the first storage tank 12 was reduced, such that it was reduced to 13 μS/cm at point J in FIGS. 8, to 5 μS/cm at point L, and to 2.5 μS/cm at point N. By time N, the water in the first storage tank had a conductivity of 2.5 μS/cm, and 62% of the total water that had entered the water purification apparatus remained.

The subsequent discharging of second CDI module caused the concentrate water to reach a conductivity of 420 μS/cm. As this conductivity is less than the initial feed water, this could be retained for the first discharge cycle of the next session of water purification thereby further improving the water recovery of the apparatus over multiple sessions.

1. A method of treating potable mains feed water to provide a purified water stream of conductivity <20 μS/cm, comprising at least the steps of:
(a) providing the potable mains feed water into a first storage tank;
(b) circulating the feed water in the first storage tank one or more times through a first purification re-circulation loop including a first capacitive deionisation module in a charging mode to provide a first purified water stream having a conductivity less than the feed water; and
(c) circulating the first purified water stream one or more times through a second purification re-circulation loop including a second capacitive deionisation module in a charging mode to provide a second purified water stream having a conductivity less than the first purified water stream.

2. The method as claimed in claim 1 wherein the first and second capacitive deionisation modules have a predetermined capacity prior to discharge, and wherein the second capacitive deionisation module is operated to a lower capacity than the first capacitive deionisation module.

3. The method as claimed in claim 2 wherein the first capacitive deionisation module is charged to >70% of its capacity prior to discharge, and the second capacitive deionisation module is charged to <70% of its capacity prior to its discharge.

4. The method as claimed in claim 1 wherein the first purification loop and the second purification loop recirculate from and return to the first storage tank.

5. The method as claimed in claim 1 wherein some of the path of the first purification re-circulation loop is the same as the path of the second purification re-circulation loop.

6. The method as claimed in claim 1 further comprising the steps of:
(d) providing water into a second storage tank;
(e) circulating the water in the second storage tank one or more times through a first concentration re-circulation loop including the first capacitive deionisation module in a discharging mode to provide a first concentrate water stream;
(f) circulating the water in the second storage tank one or more times through a second concentration re-circulation loop including the second capacitive deionisation module in a discharging mode to provide a second concentrate water stream; and
(g) passing the first concentrate water stream or the second concentrate water stream or both concentrate water streams, to a drain.

7. The method as claimed in claim 6 wherein first concentration loop and the second concentration loop recirculate from and return to the second storage tank.

8. The method as claimed in claim 6 wherein some of a path of the first concentration re-circulation loop is the same as a path of the second concentration re-circulation loop.

9. The method as claimed in claim 6 further comprising providing a first purified water stream from the first storage tank to the first concentration re-circulation loop having the first capacitive deionisation module in a discharging mode.

10. The method as claimed in claim 6 wherein the water is pumped though the first purification recirculation loop, the first concentration recirculation loop, the second purification recirculation loop, and the second concentration recirculation loop by one pump.

11. The method as claimed in claim 10 wherein the pressure out of the pump and at all points in the recirculation loops is maintained at <1 bar.

12. The method as claimed in claim 6 comprising:
running one or more first alternating cycles of a first water purification stage comprising step (b), and of a first water concentrating stage comprising step (e);
running one or more second alternating cycles of a second water purification stage comprising step (c), and a second water concentrating stage comprising step (f); and
passing the first concentrate water stream and the second concentrate water stream to a drain of step (g).

13. The method as claimed in claim 12 wherein the one or more first alternating cycles provide a purified water stream of conductivity <200 μS/cm.

14. The method as claimed in claim 12 wherein the first and second cycles occur over at least 6 hours.

15. The method as claimed in claim 12 wherein the first and second cycles occur over less than 12 hours.

16. The method as claimed in claim 12 wherein the first alternating cycles occur at least three times each.

17. The method as claimed in claim 1 wherein the purified water stream has conductivity <10 μS/cm.

18. The method as claimed in claim 1 further comprising passing water through an electrodeionisation device or module prior to the dispense.

19. The method as claimed in claim 18 wherein the purified water stream has a conductivity <0.2 μS/cm.

20. The method as claimed in claim 19 wherein the electrodeionisation module is located in a third purification re-circulation loop formed or extending from the first storage tank.

21. The method as claimed in claim 1 further comprising passing the water through a degassing membrane prior to dispense.

22. The method as claimed in claim 21 wherein the degassing membrane is located in the second purification re-circulation loop, a third purification re-circulation loop, or a combined section of the two.

23. The method as claimed in claim 1 wherein the volume of purified water having a conductivity <20 82 S/cm is >50% of the volume of the potable mains feed water provided into the first storage tank.

24. A water purification apparatus for providing a purified water stream with conductivity <20 μS/cm from a potable main feed water, comprising:
an inlet for potable water;
a first storage tank;
a pump;
a first purification recirculation loop from the first storage tank through a first capacitive deionisation module in a charging mode and returning to the first storage tank;
a second storage tank;
a first concentration recirculation loop from the second storage tank through the first capacitive deionisation module in a discharging mode and returning to the second storage tank;
a second purification recirculation loop from the first storage tank through a second capacitive deionisation module in a charging mode and returning to the first storage tank;
a second concentration loop from the second storage tank through the second capacitive deionisation module in a discharging mode and returning to the second storage tank; and
an outlet for purified water.

25. The water purification apparatus as claimed in claim 24 constructed in a single chassis, frame or housing.

26. The water purification apparatus as claimed in claim 24 wherein the apparatus is configured to fit on or under a laboratory bench or to be mounted on a laboratory wall.

27. The water purification apparatus as claimed in claim 24 wherein the working volume of the second storage tank is equal to or less than 10% of the first storage tank.

28. The water purification apparatus as claimed in claim 27 wherein the total working volume for water of the first storage tank is less than 20 litres, while the total working volume for water of the second storage tank is less than 2 litres.

29. The water purification apparatus as claimed in claim 24 further comprising an electrodeionisation device or module located to receive the water stream prior to the dispense from the water purification apparatus.

30. The water purification apparatus as claimed in claim 24 further comprising a degassing membrane.

31. The water purification apparatus as claimed in claim 24 further comprising one or more sensors to measure the conductivity of water in the first purification recirculation loop, or in the an outlet for purified water, or both.

32. The water purification apparatus as claimed in claim 24 further comprising one or more control modules to control the flow of water in one or more of the group comprising: the first purification recirculation loop, the second purification recirculation loop, the first concentration recirculation loop, and the second concentration recirculation loop.
